(19) United States
(12) Patent Application Publication
(10) Pub. No.: US 2024/0240745 A1
(43) Pub. Date: Jul. 18, 2024

(54) ADJUSTABLE STAND FOR A CAMERA

(71) Applicant: Logitech Europe S.A., Lausanne (CH)

(72) Inventors: Matthew Malone, Los Angeles, CA (US); Gaurav Bradoo, El Cerrito, CA (US); Po-Yuan Chuang, Hsinchu County (TW); Thien-Greg Ngoc Nguyen, San Ramon, CA (US); Emma Kelp-Stebbins, Portland, OR (US); Grace Hina Lee, Oakland, CA (US); Osagie Igbeare, Oakland, CA (US)

(21) Appl. No.: 18/622,670

(22) Filed: Mar. 29, 2024

Related U.S. Application Data
(63) Continuation-in-part of application No. 17/852,834, filed on Jun. 29, 2022, now Pat. No. 11,959,582.

(51) Int. Cl. F16M 11/10; F16M 11/04; F16M 11/14; F16M 11/18; G03B 17/56; H04R 1/08

(52) U.S. Cl. CPC F16M 11/105; F16M 11/045; F16M 11/046; F16M 11/14; F16M 11/18; G03B 17/561; H04R 1/08

(57) ABSTRACT

An adjustable stand for a camera with an attachment mechanism connecting the camera to a horizontal arm and a vertical pole. A user-graspable portion rotates with respect to the arm, allowing the user to hold the camera in a fixed orientation while moving the camera around, with the pole rotating and the arm extending and retracting to follow the user movement of the camera. Thus, the image orientation of an image captured by the camera is maintained, and not rotated. An extension mechanism in the arm has enough friction to hold the arm in place but allow the arm to extend and retract with respect to the pole in response to a user pulling or pushing the camera.

### CROSS REFERENCE PARAGRAPH FOR PRIORITY

This application is continuation-in-part (CIP) of U.S. Non-Provisional application Ser. No. 17/852,834, filed on Jun. 29, 2022, and titled “ADJUSTABLE STAND FOR A COMPUTER PERIPHERAL DEVICE,” which is hereby incorporated by reference in its entirety for all purposes.

The following regular U.S. patent applications (including this one) are being filed concurrently, and the entire disclosure of the other applications are incorporated by reference into this application for all purposes:
application Ser. No. ______, filed ______, entitled “ADJUSTABLE STAND FOR A CAMERA” (Attorney Docket No. 086949-1437867-151610US);
application Ser. No. ______, filed ______, entitled “ROCKER BUTTON FOR POSITION CONTROL” (Attorney Docket No. 086949-1440020-151620US).

### BACKGROUND OF THE INVENTION

Aspects of the present disclosure relate generally to adjustable stands for webcams and cameras, according to certain embodiments.

Webcams are typically attached to the top of a computer display with a clamping mechanism. Users sometimes want to provide a view of a written document to the webcam. Users can hold the document up and try to move it within the field of view of the webcam. Alternately, users can remove the webcam from the clamping mechanism, or remove the webcam and clamping mechanism together, and point it downward and move it to over the document. It would be desirable to have a better mechanism for showing documents on a webcam.

Unless otherwise indicated herein, the materials described in this section of the Specification are not prior art to the claims in this application and are not admitted to be prior art by inclusion in this section.

### BRIEF SUMMARY OF THE INVENTION

Embodiments provide an adjustable stand for a camera that is operable for stable movement in two directions with the use of a single hand of a user. An ergonomic design leverages a natural and intuitive movement of a user's hand to maintain an orientation of the camera as it moves to different 3-dimensional positions through the movement of a pole and arm.

In one embodiment, an adjustable stand for a camera is provided. The adjustable camera stand has a base with a pole extending from the base that is rotatable with respect to the base. An arm extends horizontally from the pole, with a camera attached to the arm. An attachment mechanism connects the camera to the arm, including a user-graspable portion that rotates with respect to the arm thereby allowing the user to hold the camera in a fixed orientation while moving the camera around, with the pole rotating and the arm extending and retracting to follow the user movement of the camera. Thus, the image orientation of an image captured by the camera is maintained, and not rotated. An adjustment mechanism is provided for adjusting a height of the arm on the pole. An extension mechanism in the arm has enough friction to hold the arm in place but allow the arm to extend and retract with respect to the pole in response to a user pulling or pushing the camera.

In one embodiment, the electronic device is a camera. A mechanical zoom function, that is intuitive to a user, is achieved by the user simply grasping the camera and moving it and the arm vertically along the pole.

Embodiments provide a method that enables a user to move the camera in a horizontal plane to a desired horizontal position, causing an arm rotatably attached to the camera to rotate to follow the camera position. The arm also extends and retracts with respect to a supporting pole of the adjustable stand. The user can release a clutch mechanism and move the camera vertically to achieve a desired zoom field of view, causing the arm to move vertically along the pole.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

### BRIEF DESCRIPTION OF THE DRAWINGS

The features of the various embodiments described above, as well as other features and advantages of certain embodiments of the present invention will be more apparent from the following detailed description taken in conjunction with the accompanying drawings, in which:

FIG. 1A is a diagram of an adjustable stand in a horizontal position according to certain

embodiments;

FIG. 1B is a diagram of the adjustable stand of FIG. 1A in a vertical position according to certain embodiments;

FIG. 2A is a diagram of the adjustable stand of FIG. 1A in a first position and FIG. 2B shows the corresponding view of the camera according to certain embodiments;

FIG. 2C is a diagram of the adjustable stand of FIG. 2A rotated to bring a different document into view;

FIG. 2D is a diagram showing the corresponding view of the camera according to certain embodiments;

FIG. 3 is a diagram of the adjustable stand of FIG. 1 illustrating horizontal movement according to certain embodiments;

FIG. 4 is a diagram of the adjustable stand of FIG. 1 illustrating vertical movement according to certain embodiments;

FIGS. 5A-B are diagrams of a roller mechanism for horizontal movement and support of the arm of the stand, according to certain embodiments;

FIGS. 6A-C are diagrams illustrating horizontal and vertical movement of a stand, according to certain embodiments;

FIG. 7 is a diagram illustrating a pole and arm attachment mechanism, according to certain embodiments;

FIG. 8 is a cut-away view of the pole and arm attachment mechanism, according to certain embodiments;

FIGS. 9A-B are diagrams of the attachment of the camera to the arm, according to certain embodiments;

FIGS. 10A-B are diagrams illustrating movement of the stand pole with a “Lazy Susan” base, according to certain embodiments;

FIG. 11 is a diagram illustrating a clamp support for a stand, according to certain embodiments;

FIG. 12 is a perspective view of a stand with a clamp and a “Lazy Susan” rotating base, according to certain embodiments;

FIG. 13 is a diagram illustrating a pole and arm attachment mechanism, according to certain embodiments;

FIG. 14 is a diagram illustrating a stand with adjustable pole and arm clamps limiting horizontal and vertical movement, according to certain embodiments;

FIG. 15 is a diagram of a stand with an angled pole, according to certain embodiments;

FIG. 16 is a diagram illustrating a telescoping arm for a stand, according to certain embodiments;

FIG. 17 is a graphical illustration of the vertical zoom movement of a stand, according to certain embodiments;

FIG. 18 is a diagram of a camera grab ring and a pole slide mechanism, according to certain embodiments;

FIGS. 19-20 are diagrams of an arm slide mechanism, according to certain embodiments;

FIG. 21 is a diagram of the details of the slide mechanisms of FIGS. 19 and 20, according to certain embodiments;

FIG. 22 is a diagram of an adjustable camera stand with an alternative camera support mechanism according to certain embodiments;

FIG. 22A is a diagram illustrating the counteracting rotations of the camera and the camera arm on the base according to certain embodiments;

FIGS. 22B-D are diagrams illustrating the different rotational directions of the camera according to certain embodiments;

FIG. 23 is a diagram of the camera attachment mechanism of FIG. 22 according to certain embodiments;

FIG. 24 is a diagram of an exploded view of the camera attachment mechanism of FIG. 23 according to certain embodiments;

FIG. 25 is a diagram of an exploded slip ring of FIG. 24 according to certain embodiments;

FIG. 26 is a diagram of an embodiment of a position adjustment button that can accessed from different directions, according to certain embodiments;

FIG. 27 is a cut-away view of the position adjustment button of FIG. 26, according to certain embodiments;

FIG. 27A is a diagram of the internal rack gear of FIG. 27, according to certain embodiments;

FIGS. 28A-C are cut-away views illustrating the pivoting of the position adjustment button when pressed from above or below, according to certain embodiments;

FIGS. 29A-B are views illustrating the button and its inner portion in more detail, according to certain embodiments;

FIG. 30 is a cutaway view illustrating button 2602 and its connection to arm 2714, according to certain embodiments;

FIG. 31 is a simplified block diagram of a computing device, according to certain embodiments; and

FIG. 32 is a flowchart of a method for operating an elongated button, according to certain embodiments.

### DETAILED DESCRIPTION OF THE INVENTION

Aspects of the present disclosure relate generally to adjustable stands for computer peripheral devices, and in particular for cameras or webcams, according to certain embodiments.

In the following description, various examples of an adjustable stand for computer peripheral devices are described. For purposes of explanation, specific configurations and details are set forth to provide a thorough understanding of the embodiments. However, it will be apparent to one skilled in the art that certain embodiments may be practiced or implemented without every detail disclosed. Furthermore, well-known features may be omitted or simplified to help to prevent any obfuscation of the novel features described herein.

The following high-level summary is intended to provide a basic understanding of some of the novel innovations depicted in the figures and presented in the corresponding descriptions provided below. Aspects of the invention address the problem of a user trying to position a camera to alternately view the user or different documents on a user's desktop.

Aspects of the invention solve this problem by providing an adjustable stand for a camera or other electronic device that allows intuitive positioning by grasping the electronic device and moving it to the desired position, with a supporting arm of the adjustable stand moving with the electronic device.

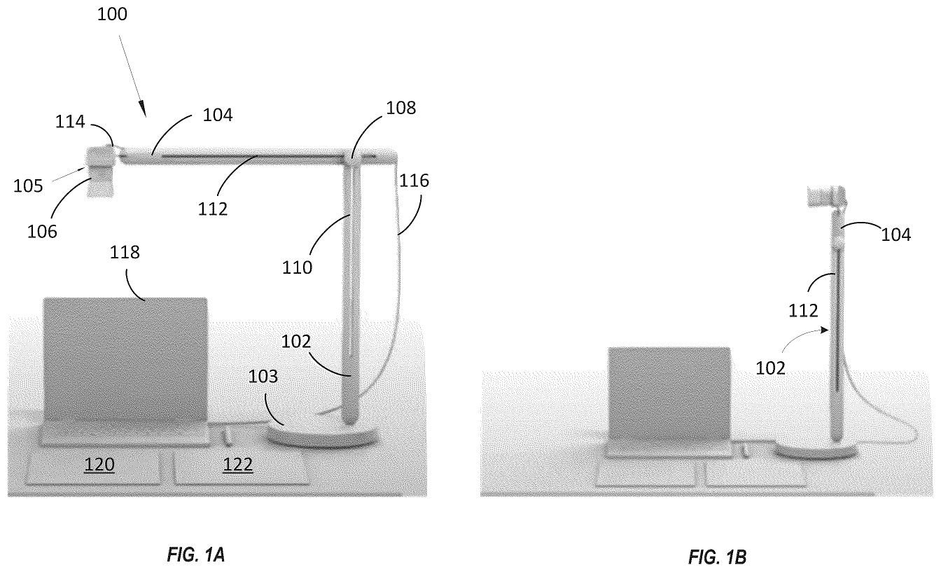

In one embodiment, an adjustable stand 100, as shown in FIG. 1A, for an electronic device is provided. The adjustable stand has a base 103 with a pole 102 extending vertically from the base. An arm 104 extends from the pole, the arm being extendable horizontally and being vertically rotatable between a horizontal and vertical position. An adjustment mechanism 108 adjusts the height of the arm on the pole. An electronic device 106 is attached to the arm, the electronic device being rotatable at least 180 degrees with respect to the arm. In one embodiment, the electronic device is a camera, and is rotatable 360 degrees. A mechanical zoom function that is intuitive to a user is achieve by the user simply grasping the camera and moving it vertically along the pole.

Embodiments enable a user to move the camera 106 in a horizontal plane to a desired horizontal position, causing arm 104 to rotate to follow the camera position. The arm also extends and retracts with respect to supporting pole 102 of the adjustable stand. The user can release a clutch mechanism and move the camera vertically to achieve a desired zoom field of view, causing the arm to move vertically along the pole.

In alternate embodiments, the electronic device can be a camera, light, 3D mouse, microphone, etc.

Other examples, embodiments, modifications, etc., are possible and some are described in further detail below.

It is to be understood that this high-level summary is presented to provide the reader with a baseline understanding of some of the novel aspects of the present disclosure and a roadmap to the details that follow. This high-level summary in no way limits the scope of the various embodiments described throughout the detailed description and each of the figures referenced above are further described below in greater detail and in their proper scope.

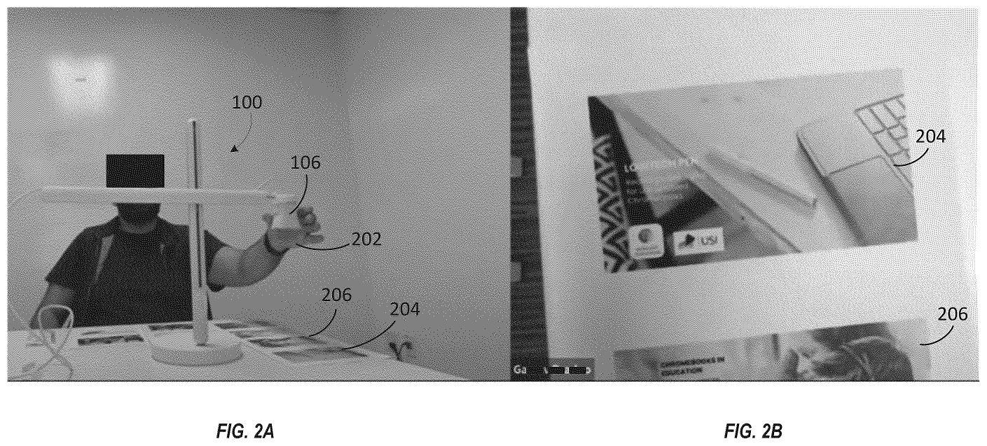

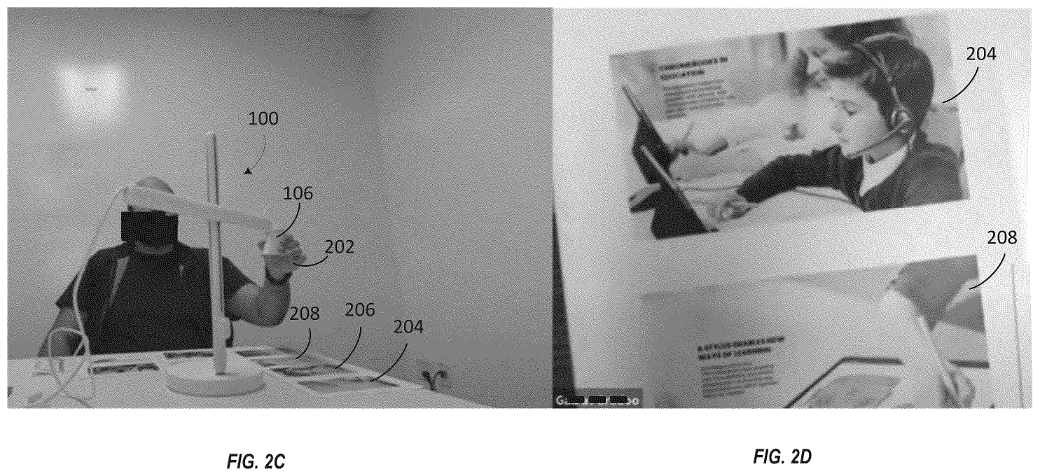

FIG. 1A is a diagram of an adjustable stand 100 in a horizontal position according to certain embodiments. A pole 102 extends vertically from a base 103. The base can include weights to provide stability, such as 800 grams, or between 500 grams and 1 kilogram. An arm 104 extends horizontally from pole 102. An electronic device 106 (e.g., a camera) is suspended from arm 104. A clamping mechanism includes a button 108 that releases a clamp inside pole 102 to allow arm 104 to move vertically in a slot 110 in pole 102. A slot 112 in arm 104 engages an attachment mechanism (not shown) on pole 102. The attachment mechanism allows the arm to be move horizontally by a user pushing or pulling electronic device 106. The attachment mechanism also allows arm 104 to be rotated through a range of angles to a vertical position as shown in FIG. 2.

A cable 114 is connected to electronic device 106 to provide both power and data transfer. The cable runs in a channel in arm 104 and comes out the other end of arm 104 at a cable portion 116, which can be connected to a computer 118. In one embodiment, electronic device 106 is a camera or webcam, and can be rotated at least 180 degrees, or 360 degrees using a ball joint 105, or a donut ring with ball-bearings, or a gooseneck connection, or simply a smooth engagement ring surface to allow rotation. The camera will move counter to the arm, maintaining an image location in the camera's field of view. The camera 106 can be positioned to capture images of papers 120 and 122 on a user's desk.

As can be seen in FIG. 1A, the camera 106 can also be placed in a classic webcam position to show the user. The arm 104 can be lowered to be at the height of the top of computer 118. The arm can be moved side-to-side until it is in a middle position over computer 118. The camera 106 can be rotated so that it is pointed toward the user.

FIG. 1B is a diagram of the adjustable stand of FIG. 1A in a vertical position according to certain embodiments. Arm 104 has been rotated 90 degrees from its position in FIG. 1A to a vertical position, and has been slid down, with button 108 staying stationary while slot 112 moved past it until button 108 is at the other end of slot 112 from the position in FIG. 1A.

FIG. 2A is a diagram of the adjustable stand 100 of FIG. 1A in a first position and FIG. 2B shows the corresponding view of the camera. As shown, the camera 106 is above an image 204, which is shown in the camera view of FIG. 2B. Next to image 204 is a second image 206. A user's hand 202 can grasp camera 106 to move it over image 206, as shown in FIGS. 2C-D.

FIG. 2C is a diagram of the adjustable stand 100 of FIG. 2A rotated to bring a different document into view, and FIG. 2D shows the corresponding view of the camera. As can be seen, the user's hand has pulled the camera 106 closer to the user, with the adjustable stand rotating to follow the user's hand. The camera has moved from having document 204 in its view, to having the next document 206 in its view, as can be seen from FIG. 2D. Also, a third document 208 is now partially in view. As can be seen, the orientation of the camera 106 has remained basically the same. In other words, the camera has not rotated with the arm 104 of the stand since the user's hand is holding the camera, causing it to rotate around the ball joint as the arm is rotated.

Thus, the user's natural motion of holding the camera is leveraged by this invention to keep it in the same orientation as the camera stand is rotated. The user's hand and arm act as another arm connected to the camera, fixing it in position and keeping it in generally the same orientation relative to the user. The movement of the camera with the user's hand pulls the arm 104 with it, causing rotation with a movement that is very intuitive to a user. The user simply has to move the camera itself to where the user wants it, and the stand follows. Thus, the user can position the camera where desired using a single hand.

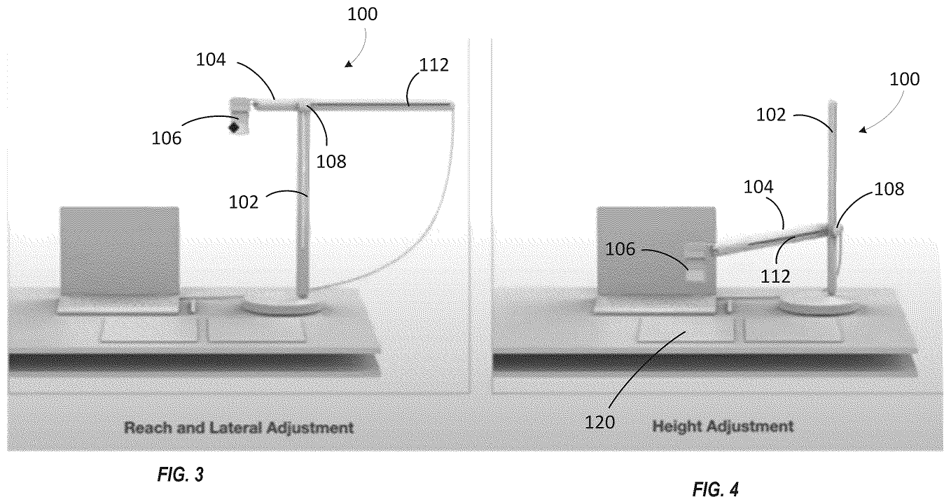

FIG. 3 is a diagram of the adjustable stand 100 of FIG. 1A illustrating horizontal movement according to certain embodiments. As shown, arm 104 has moved relative to the position in FIG. 1A, with camera 106 now closer to vertical pole 102. Arm 104 has moved to the right, so that button 108, which has not moved, is now at the other end of slot 112.

FIG. 4 is a diagram of the adjustable stand 100 of FIG. 1A illustrating vertical movement according to certain embodiments. As can be seen, arm 104 has moved downward so that camera 106 is closer to document 120. Button 108 has moved downward along a slot in vertical pole 102. This provides a manual zoom, with the image of document 120 becoming bigger until if fills the entire camera image and then zooms in on an aspect of document 120. The document stays centered in the field of view of the camera due to the positioning of the arm. Thus, a complex zoom system that requires a user to twist a dial or other mechanism on a camera, at the same time as moving it over the document, is avoided. Rather, the user can operate the zoom intuitively—by moving the camera closer to the document. Arm 104 has also been tilted vertically to the position in FIG. 4, and is no longer strictly horizontal.

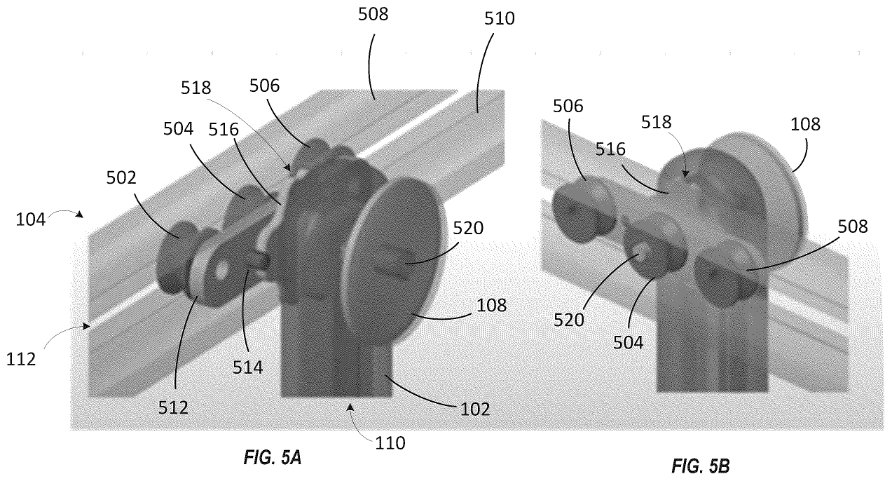

FIGS. 5A-B are diagrams of a roller mechanism for horizontal movement and support of the arm 104 of the stand 100, according to certain embodiments. Three rollers 502, 504 and 506 are mounted to engage with upper member 508 and lower member 510 of arm 104. The upper and lower members define the slot 112 within which the rollers move. The rollers both support arm 104, and allow horizontal movement of arm 104 as slot 112 moves across the rollers. Three rollers are used to provide stability for arm 104, and prevent rocking side-to-side and back-and-forth. Alternately, four or more rollers could be used. In one embodiment, bearings are used inside the rollers. Alternately, bearings could be used instead of rollers, or any other mechanism that stably supports the arm and allows horizontal movement and vertical rotation. Although the rollers are shown as having a V-shaped groove, alternatively the arm channel they ride in could have the V-shaped groove with the rollers having a jutting V.

The rollers are mounted on an arm plate 512, which is supported by an axle 520 attached to button 108. Arm 104 can move horizontally along the rollers, and also rotate vertically around axle 520. As it rotates, a positioning member (peg) 514 on arm plate 512 can engage one of 4 detents 518 in a clutch plate 516, to fix it in the most desired positions—exactly horizontal or vertical. In one embodiment, clutch plate 516 is two plates with a metal spring in-between. Alternately, a different number of detents, or no detents, could be used. Detents could be provided every 15, 30 or 45 degrees, for example.

FIG. 5B is a back-side diagram of the arm support structure of FIG. 5A. Axle 520 can be seen supporting roller 504. Axle 520 is also shown in FIG. 5A. Alternately, axle or shaft 520 can be in a fixed position in arm plate 512, between two of the rollers. Button 108 can be pushed inward against a spring mechanism to allow the arm 104 to move vertically in slot 102. This is described in more detail below.

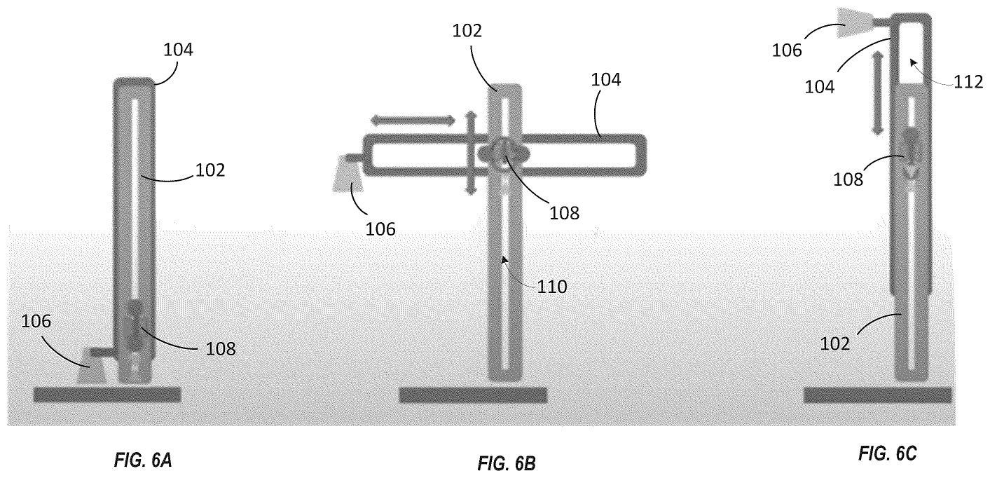

FIGS. 6A-C are diagrams illustrating horizontal and vertical movement of a stand, according to certain embodiments. FIG. 6A shows the stand in a compact position, with arm 104 rotated vertically and moved down to be essentially co-extensive with pole 102. Button 108, which fixes arm 104 to pole 102, is near the bottom, as is the camera 106 at the end of arm 104. In one embodiment, the camera can have a rechargeable battery that can be inductively charged from a charger in the base of the stand when the camera is in the position shown in FIG. 6A.

FIG. 6B shows arm 104 moved upward, which is done by pressing button 108 to release a clamping mechanism inside, then sliding arm 104 up slot 110 in pole 102. The arm 104 is then rotated to a horizontal position, where a detent is engaged and the button is released to clamp arm 104 at that height. The arm has been slid to the left, so that button 108 is in the middle, moving the arm from its position in FIG. 6A where the button was at the end of arm 104 near camera 106. Alternately, arm 104 can freely slide along the horizontal length, and not be clamped into position, allowing the button to be at any height along arm 102 when arm 104 is vertically aligned with it, or along any length of arm 104 when it is in its horizontal positioning.

FIG. 6C shows arm 104 rotated to the vertical position shown from the horizontal position shown in FIG. 6B. Arm 104 can move upward in two ways. Button 108 can be depressed to release the clamp, and the button can move the arm upward. Also, with the button holding the arm to a fixed height on pole 102, arm 104 can be moved upward along its rollers until button 108 is at the low end of slot 112.

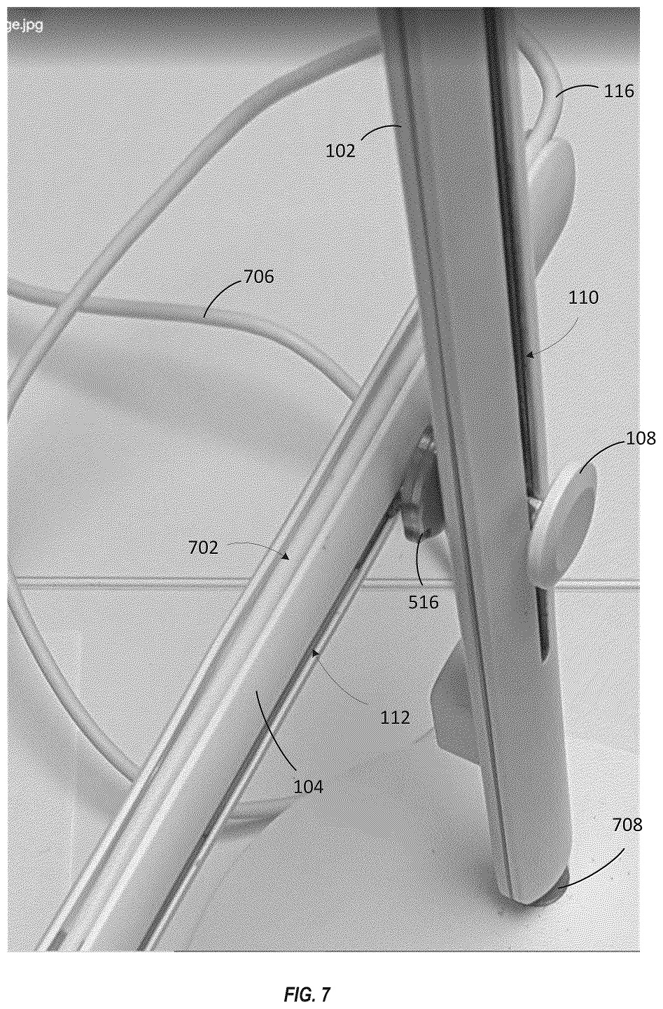

FIG. 7 is a diagram illustrating a pole and arm attachment mechanism, according to certain embodiments. A channel 702 is shown in the top of arm 104, through which cable 116 can run, so that the cable isn't dangling from the camera. Cable 116 is a DC cable that connects directly to a DC power source, such as a USB port on a computer. In one embodiment, data and power can be provided along the same cable, providing the camera images to the USB or other port of the computer or other computing device. Alternately, the data can be sent wirelessly.

FIG. 7 shows a rotating mechanism 708 that allows pole 102 to rotate 360 degrees with respect to the base. The rotating mechanism can include a ball-bearing ring or rollers or a bushing or another mechanism. In one embodiment, the camera is powered directly through the arms via contact points in 708 and then a DC-AC connection from the base to a wall outlet, or a USB from the base to computer for power or Power over Ethernet (POE).

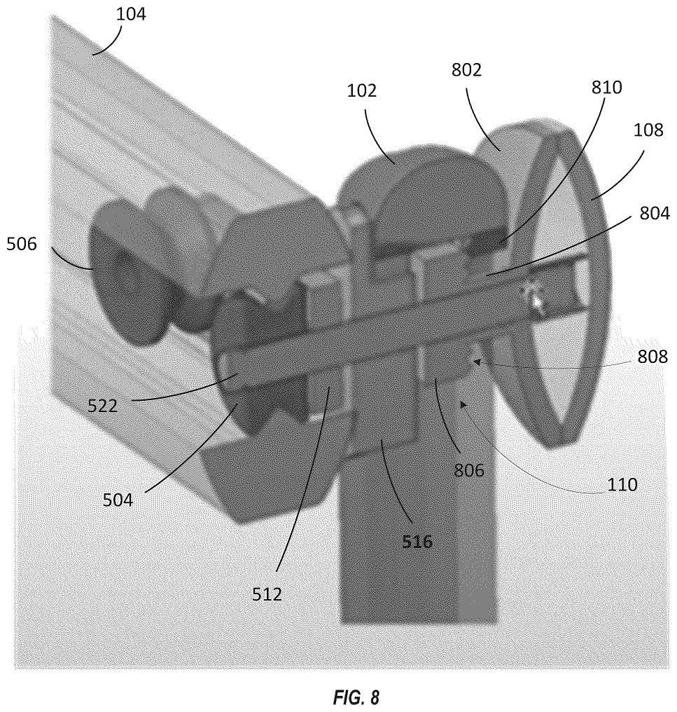

FIG. 8 is a cut-away view of the pole and arm attachment mechanism, according to certain embodiments. As described before, rollers 506 and 504 support arm 104 on an arm plate 512, with middle roller 504 rotating around an axle 522 connected to button 108, which holds the arm at a certain height on pole 102. Rotation positions can engage detents in clutch plate 516. Button 108 has a compressible back portion 802 molded to a support member 804 which supports a block 806. Block 804 has serrated ridges 808 which engage a complementary surface on the inside of slot 110 of pole 102. When button 108 is pushed, portion 802 acts like a spring, and compresses, allowing button 108 to push axle 522, which is connected to block 806 and pushes the serrated ridges 808 away from the complementary ridges of pole 102, thus disengaging. This allows the arm 104 to move up and down along slot 110 as long as button 108 is pressed. When button 108 is released, compressible back portion 802 pushes outward, pulling the serrated ridges 808 back into engagement with the corresponding serrated ridges of pole 102, fixing arm 104 at that height. Alternately, axle 522 may only extend to arm plate 512 and the rollers have a separate shaft to roll on.

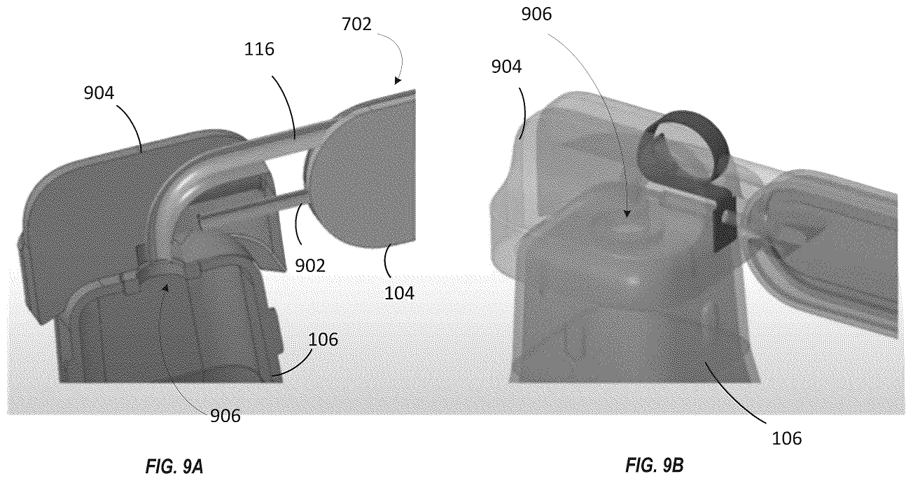

FIGS. 9A-B are diagrams of the attachment of the camera to the arm, according to certain embodiments. A rod 902 extends from arm 104 to attach to camera holder 904 and allows rotation around the axis of the rod 902. The camera is also connected to the camera holder 904 by a ball joint, ball-bearing ring or other mechanism, not shown in this view, which allows rotation around an axis perpendicular to rod 902. A connection of the cable 116 to the camera, not shown, has slack to allow the camera (in the holder) to rotate with respect to the arm without causing the cable to disconnect or tear. Cable 116 extends through a hole 906 in cap 904 to connect to camera 106.

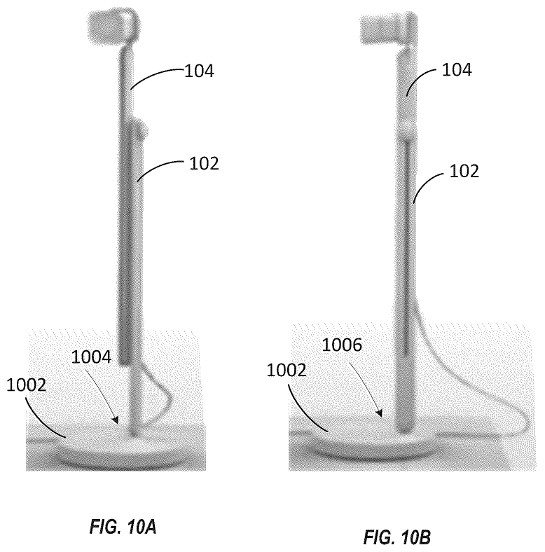

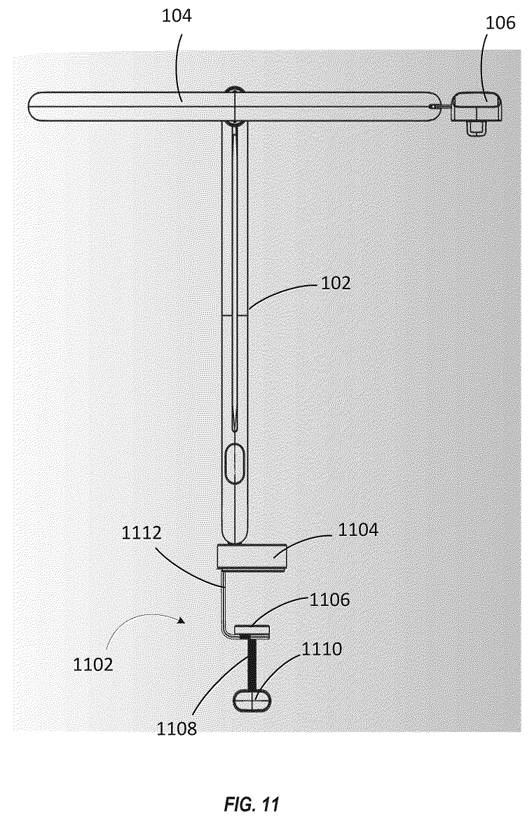

FIGS. 10A-B are diagrams illustrating movement of the stand pole with a “Lazy Susan” base, according to certain embodiments. The arm 104 is arranged in a vertical position with respect to pole 102. Base 1002 rotates, in a “Lazy Susan” arrangement, with pole 102 moving around the perimeter of base 1002 from a position 1004 in FIG. 10A to a position 1006 in FIG. 10B.

FIG. 11 is a diagram illustrating a clamp support for a stand, according to certain embodiments. A clamp 1102 can hold a base 1104 on the edge of a desk. The clamp has a bottom part 1106 supported by a bracket 1112, that can be screwed upward with a screw 1108 by turning a handle 1106. Base 1104 can be any type of base, and can allow rotation, such as by the Lazy Susan arrangement shown in FIGS. 10A-B.

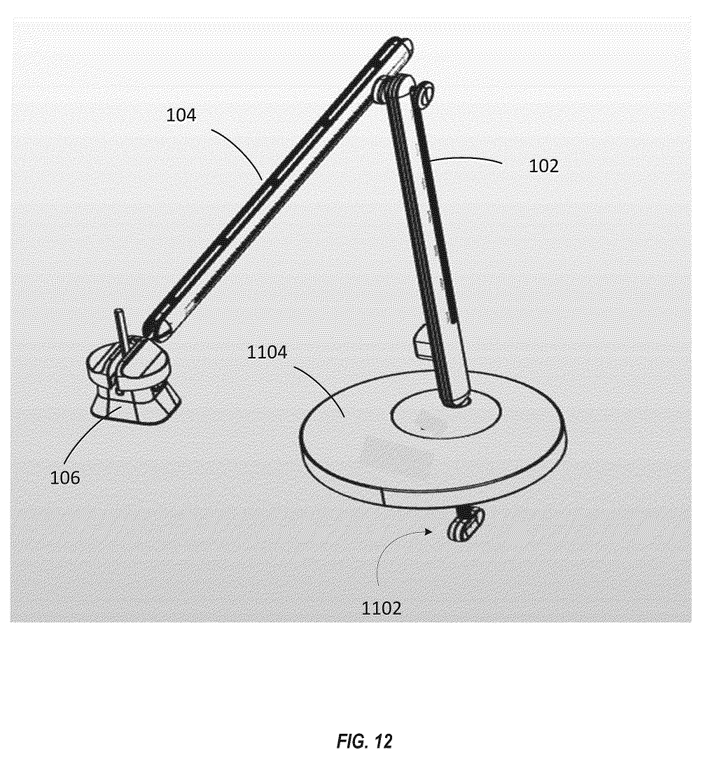

FIG. 12 is a perspective view of a stand with a clamp 1102 and a “Lazy Susan” rotating base 1104, according to certain embodiments.

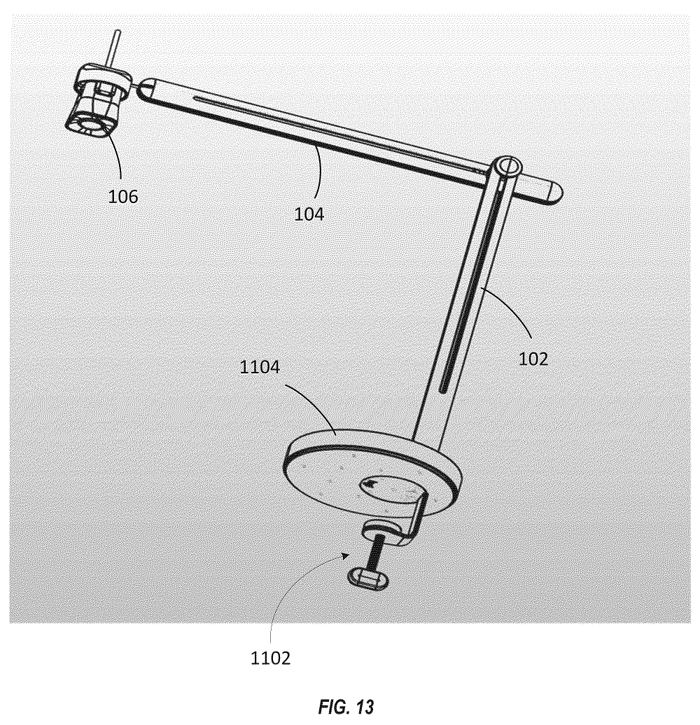

FIG. 13 is a diagram illustrating the clamp and Lazy Susan arrangement of FIG. 12 from below, according to certain embodiments.

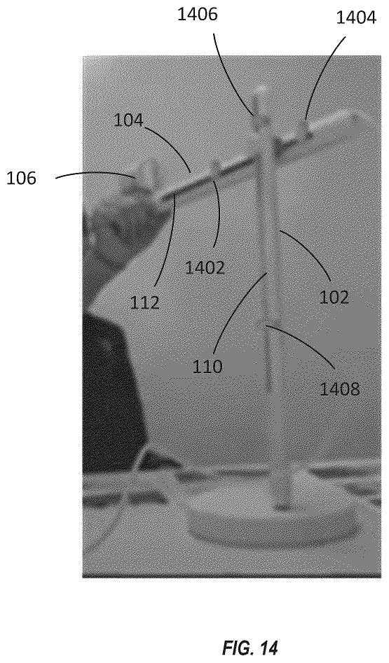

FIG. 14 is a diagram illustrating a stand with adjustable pole and arm clamps limiting horizontal and vertical movement, according to certain embodiments. Arm clamps 1402 and 1404 slide within slot 112 of arm 104 to desired limit positions set by a user Similarly, pole clamps 1406 and 1408 slide within slot 110 of pole 102 to desired positions to limit vertical travel. The arm and pole clamps can have a similar mechanism to button 108, described earlier. A user may want to limit travel to keep the camera over a designated document area on a desk, or to keep the arm from hitting a nearby wall, or for any other reason. In an alternate embodiment, instead of clamps, detents can be used at the clamp positions, and at additional positions. The detents urge the arm into that position, but allow the arm to be pushed beyond the detent, or pulled away from it. The detents provide tactile feedback to the user on a maximum advisable position or optimum positions for different uses.

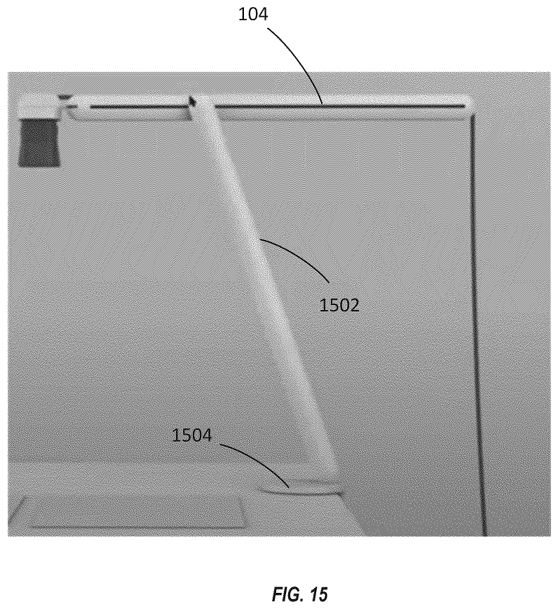

FIG. 15 is a diagram of a stand with an angled pole 1502, according to certain embodiments. Pole 1502 can tilt upward or downward, providing the height adjustment in this manner. The pole 1502 could still rotate, either around where it is connected to base 1504, or in a Lazy Susan or other arrangement.

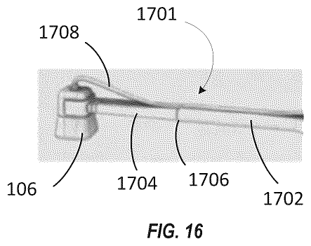

FIG. 16 is a diagram illustrating a telescoping arm for a stand, according to certain embodiments. Camera 106 is held by arm 1701, which has a first arm 1702 with a second arm 1704 which telescopes in and out of first arm 1702 at an opening 1706. Cable 1708 has sufficient slack to be able to extend to the camera 106 when second arm 1704 is in the fully extended position. In alternate embodiments, a third telescoping arm could be added. Additionally, or instead, the pole could be telescoping. The telescoping arm can be added to the tilted pole of FIG. 15, or to any of the other embodiments herein.

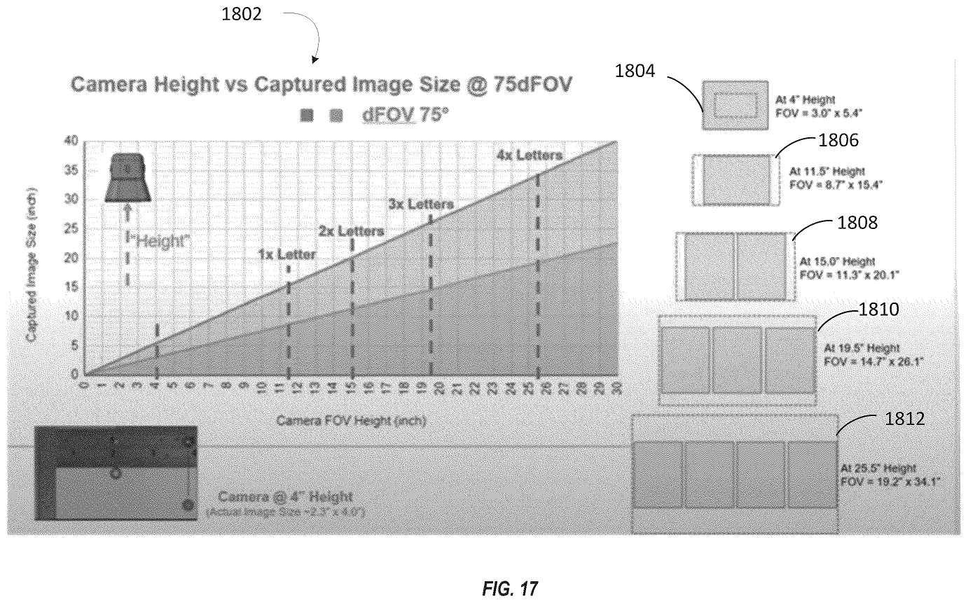

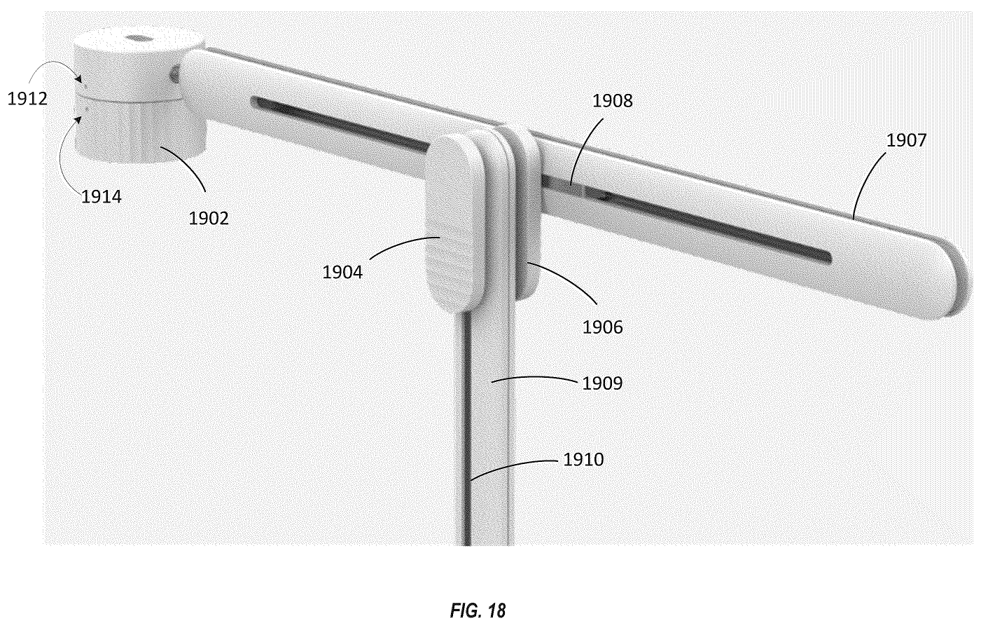

FIG. 17 is a graphical illustration of the vertical zoom movement of a stand, according to certain embodiments. A graph 1802 shows that as the height of the camera is raised, the field of view (FOV) of the camera increases. Conversely, as the camera is lowered, the FOV decreases, giving a close-up view. This, raising and lowering the camera gives a zoom feature that is intuitive and easy for a user. The images on the right illustrate the FOV of the camera at different heights in one embodiment. Image 1804, at a height of 4 inches, provides a FOV sufficient for a business card. Image 1806, at a height of 11.5 inches, provides a FOV sufficient for a standard 8 ½×11 inch letter paper, with a FOV of 8.7×15.4 inches. An image 1808 at a height of 13 inches provides a FOV sufficient for 2 letter documents, with a FOV of 11.3×20.1 inches. An image 1810 at a height of 19.5 inches provides a FOV sufficient for 3 letter documents, with a FOV of 14.7×26.1 inches. An image 1812 at a height of 25.5 inches provides a FOV sufficient for 4 letter documents, with a FOV of 19.2×34.1 inches.

### Alternate Clamp Embodiments

FIG. 18 is a diagram of a camera grab ring and a pole slide mechanism, according to certain embodiments. A grab ring 1902 has outer serrations to provide a friction surface for the user to grasp. Indicators 1912 and 1914 show an initial camera position. As grab ring 1902 is rotated, indicator 1914 on the grab ring will move with respect to indicator 1912, giving visual feedback to the user of the amount of rotation. This also allows the user to return the camera to the original position by aligning the indicators again.

Two slide tabs 1904 and 1906 are shown as part of a pole slide mechanism. Tab 1906 is connected to a block 1908 in the arm 1907 to hold the arm. When tabs 1904 and 1906 are pinched together, the arm can slide up and down the pole 1909 along slot 1910.

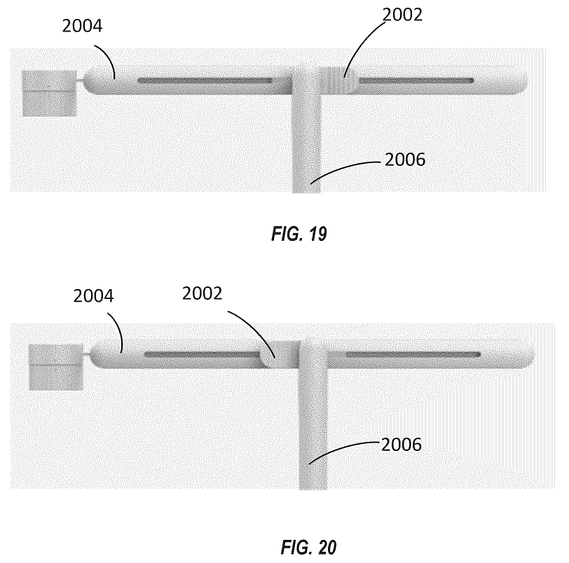

FIGS. 19-20 are diagrams of an arm slide mechanism, according to certain embodiments. FIG. 19 shows arm slide lever 2002 in one embodiment, to the right of pole 2006 along arm 2004. FIG. 20B shows the arm lever in an alternative embodiment to the left of the pole 2006. The user can hold the arm 2004 and pinch the lever 2002 into the arm 2004 releasing a mechanism that allows the user to move the arm 2004 along pole 2006. When the lever 2002 is released, the mechanism is engaged keeping the arm 2004 at the position along the pole where it was left.

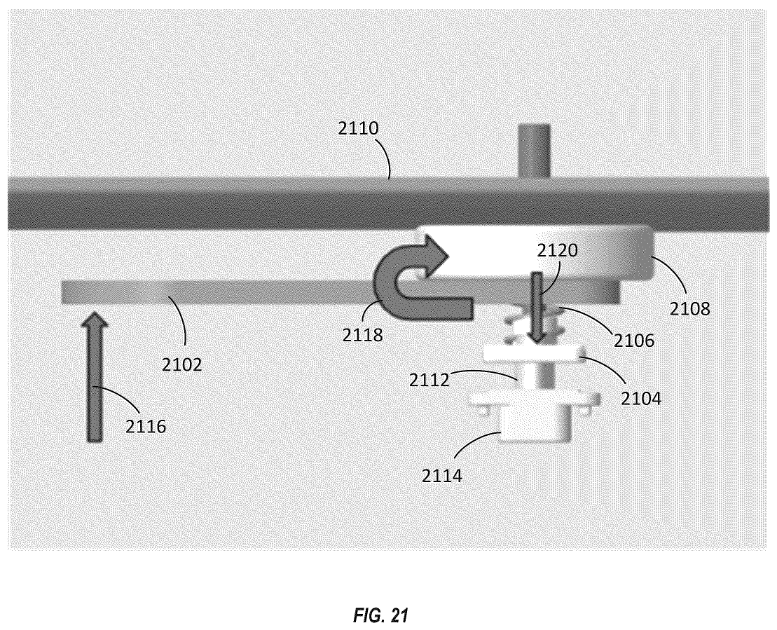

FIG. 21 is a diagram of the details of the slide mechanisms of FIGS. 19 and 20, according to certain embodiments. A tab 2102 is biased by a plate 2104 and spring 2106 to pressure a block 2108 against and arm or pole 2110. These elements are mounted on a rod 2112 which is anchored in a block 2114. When a user pinches tab 2102, as indicated by arrow 2116, tab 2102 rotates about the edge of block 2108 as indicated by arrow 2118, causing an end of tab 2102 to move downward as indicated by arrow 2120, compressing spring 2106. This lessens the pressure on arm or pole 2110, allowing movement along rod 2112.

In one embodiment, a switch is provided on the camera to rotate between portrait and landscape FOV. In another embodiment, the camera has a light (e.g, a ring light) for illuminating not only a user's face, but also documents. In other embodiments, haptic or vibration feedback is provided for when document is optimally in field of view. Software code in a camera application on the computer determines when the document is within the field of view, by detecting the document separately from the desktop, as is done for scanning applications. In an alternate embodiment, the camera can slide along the arm, instead of the arm sliding with respect to the pole.

### Camera Support Mechanism

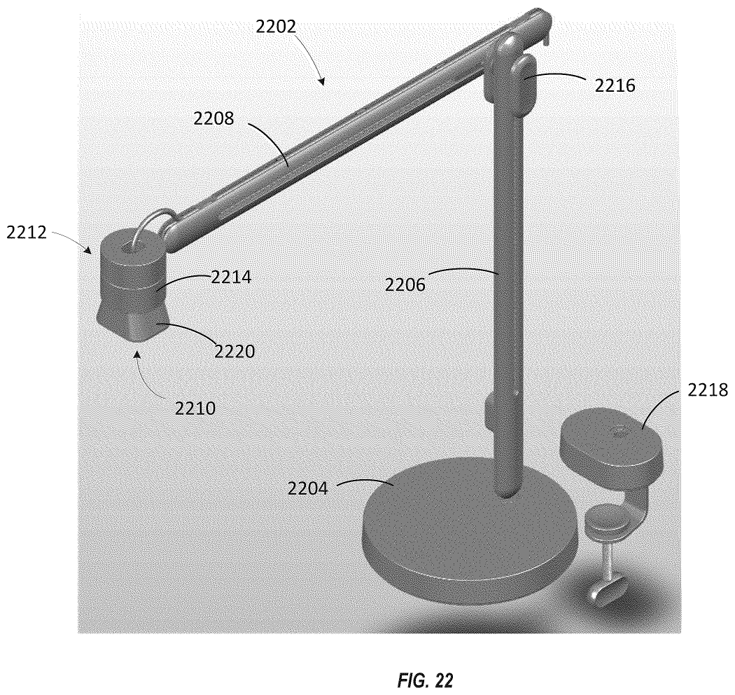

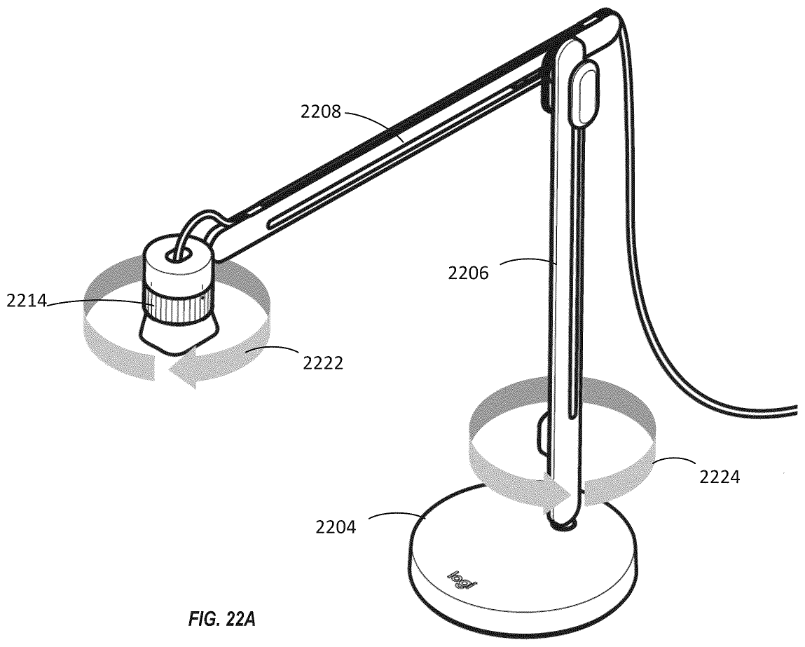

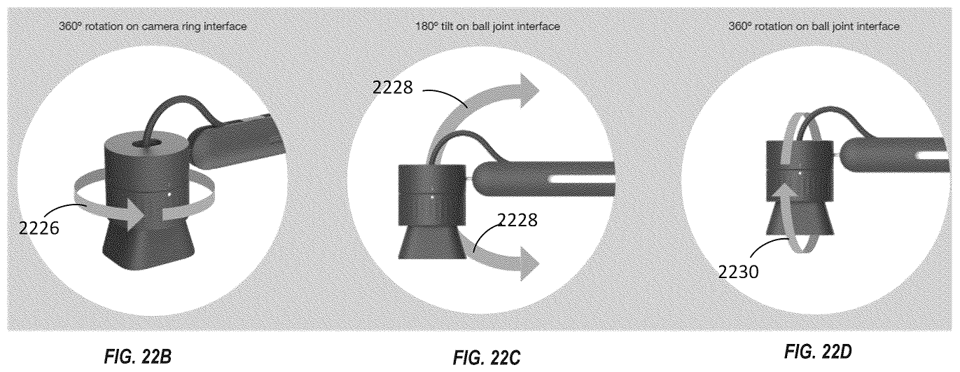

FIG. 22 is a diagram of an adjustable camera stand 2202 with an alternative camera support mechanism according to certain embodiments. The adjustable camera stand has a base 2204 with a pole 2206 extending from the base that is rotatable with respect to the base. An arm 2208 extends horizontally from the pole, with a camera 2210 attached to the arm. A camera attachment mechanism 2212 connects the camera to the arm through rod 902, as referenced previously, that has a ball trapped in the end of arm 2208 allowing the camera and mount to be rotated in 2 axes about the arm 2208. A user-graspable portion 2214 rotates with respect to the arm thereby allowing the user to hold the camera in a fixed orientation while moving the camera around, with the pole 2206 rotating and the arm extending and retracting to follow the user movement of the camera. Thus, the image orientation of an image captured by the camera is maintained, and not rotated. A button-controlled adjustment mechanism 2216 is provided for adjusting a height of the arm on the pole. An extension mechanism in the arm, such as described in above embodiments, has enough friction to hold the arm in place but allow the arm to extend and retract with respect to the pole in response to a user pulling or pushing the camera. An alternative base 2218 allows the base to be clamped onto the side of a desk.

The camera 2220 has a rectangular housing below the user-graspable portion 2214, providing visual feedback to the user of the orientation of the camera. This aids the user in maintaining the orientation (e.g., portrait or landscape) of the camera as the user pulls the camera over a different object (see description of FIG. 2C above). In some embodiments, digital processing can aid in maintaining the orientation of the camera. The user's hand may not be completely steady, and the software can correct alignment to keep a paper, photo, or other object in the view of the camera aligned. The user could activate this feature by pressing a button on the camera or somewhere on the stand, or by a hand gesture in the field of view of the camera. Alternatively, a capacitive sensor can detect the presence of the user's fingers on the user-graspable portion 2214. The sensor signal is provided to a processor, which processes the image to detect the shape of a paper or image in the view of the camera. In one embodiment, it can be aligned to be in a portrait or landscape position and maintained in that position. In another embodiment, the orientation before movement of the camera can be detected, and the image processing in software can adjust the orientation to maintain the same alignment of the image despite any slight twisting by the user.

FIG. 22A is a diagram illustrating the counteracting rotations of the camera and the camera arm on the base according to certain embodiments. FIG. 22A shows that when the user grasps portion 2214 and moves it while maintaining the image orientation, the camera will rotate as indicated by arrow 2222 with respect to arm 2208 to maintain the image orientation. At the same time, arm 2208 will rotate with respect to base 2224 to provide a counteracting rotation that helps keep the image orientation level.

FIGS. 22B-D are diagrams illustrating the different rotational directions of the camera according to certain embodiments. FIG. 22B shows 360 degrees rotation on the camera ring interface as shown by arrow 2226. FIG. 22C shows 180 degrees rotation on the ball joint interface to the arm as shown by arrow 2228. FIG. 22D shows 360 degrees rotation on the ball joint interface to the arm in the direction indicated by arrow 2230.

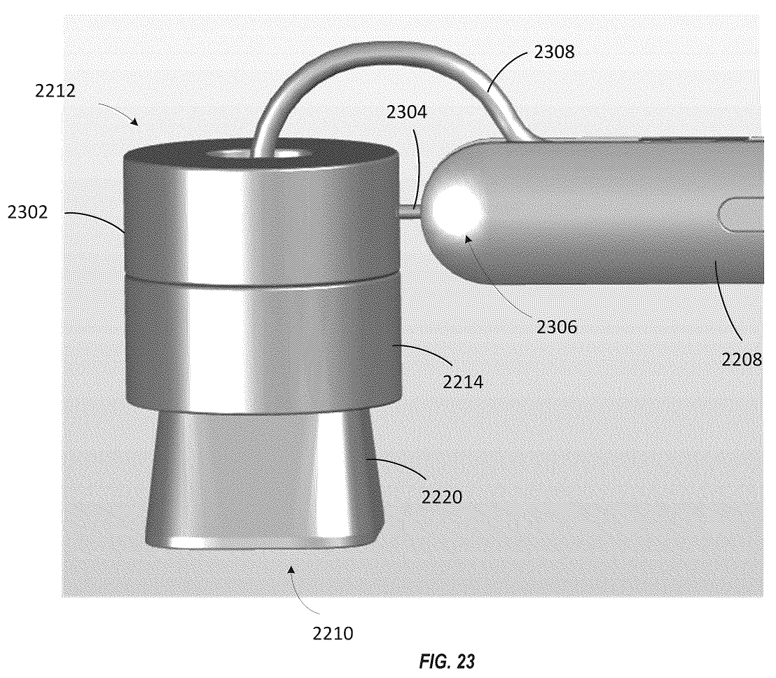

FIG. 23 is a diagram of camera attachment mechanism 2212 of FIG. 22 according to certain embodiments. User-graspable portion 2214 attaches to a housing 2302 through an internal slip ring (not visible in FIG. 23), thus allowing rotation of user-graspable portion 2214 with respect to housing 2302. Housing 2302 is attached to arm 2208 via a member 2304, which connects to a ball-joint (not visible) internal to arm 2208 at position 2306. A cable 2308 provides an electrical connection to the camera. As described below, the rotation of the camera is limited to 360 degrees (in the directions shown in FIGS. 22B, D) to keep the cable from becoming tangled or stressed. As the user moves the camera by grasping portion 2214, housing 2302 remains fixed with respect to arm 2208, pushing or pulling the arm in response to movement by the user. The ball joint allows side-to-side movement of the camera by the user tilting camera adjustment mechanism 2212.

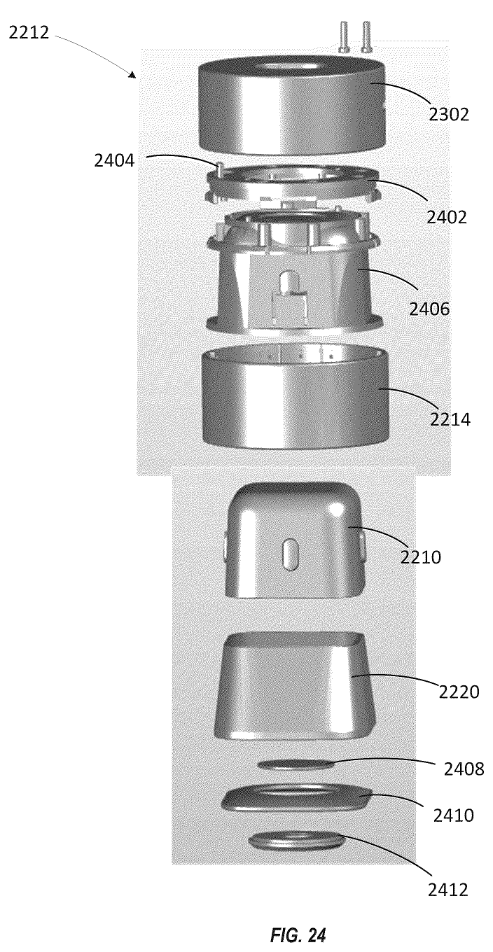

FIG. 24 is a diagram of an exploded view of the camera assembly and camera attachment mechanism 2212 of FIG. 23 according to certain embodiments. User-graspable portion 2214 attaches to housing 2302 through an internal slip ring 2402. A stop 2404 prevents rotation of more than 360 degrees of the slip ring, which would tangle the cable. Slip ring 2402 is screwed into an internal housing 2406, which is snapped into place in 2214. Housing 2302 freely spins on the outer circumference of 2402, while a separate stop 2404 can slide about 10 degrees to allow a full 360 degrees of rotation of 2214 relative to 2302. User-graspable portion 2214 is mounted around internal housing 2406 which holds a camera 2210 stationary with respect to the user-graspable portion. Also shown are a camera lens 2408, a lens capture part 2410 to retain the lens in place and a lens hood 2412.

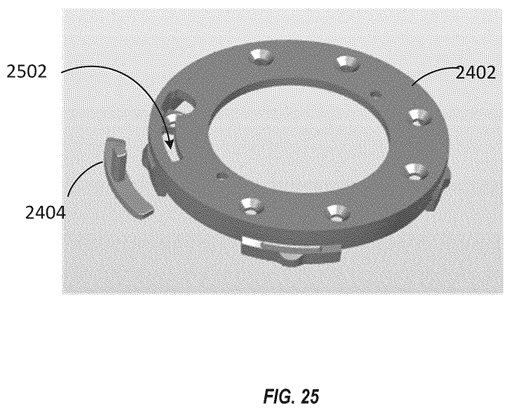

FIG. 25 is a diagram of an exploded slip ring 2402 of FIG. 24 according to certain embodiments. Stop 2404 is shown removed from a slot 2502 where it resides. As can be seen, there is a little play, so that turning past the position of stop 2404 is allowed, providing a full 360 degrees of turning, not 360 less the width of the stop.

In certain embodiments sound is captured along with an image. For example, the camera may be used to demonstrate the clicking operations of a mouse, or the playing of keys on a piano. An array of microphones can be provided to capture these sounds. In one embodiment, the microphones are mounted in housing 2302 with holes providing access for sound. Alternatively, the microphones can be mounted around the camera lens, pointing down. Beamforming can be used to detect the origin of sounds and to activate the appropriate microphones in the array.

### Rocker Button for Position Control

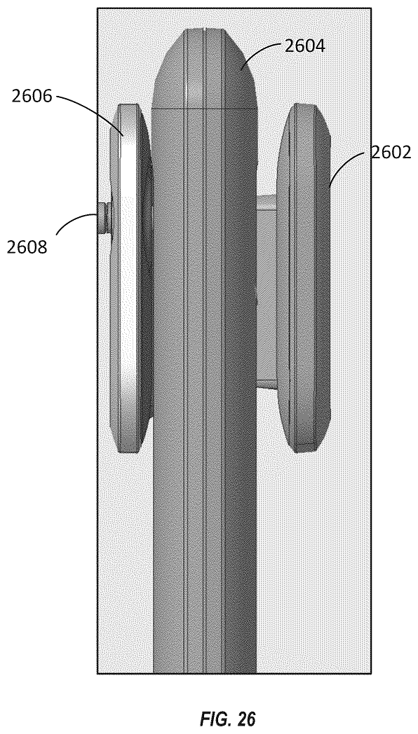

FIG. 26 is a diagram of an embodiment of a position adjustment button that can be accessed from different directions, according to certain embodiments. Some of the other button designs, such as button 108 of the above embodiments, provides a circular button that can be difficult to access and press from behind or the side. FIG. 26 illustrates an elongated pivot button 2602 that can be accessed and easily activated from different directions. In the embodiment shown, it attaches to a pole 2604 with a mechanism that releases when button 2602 is pressed, allowing it to move vertically along with an attached backside member 2606 which is attached by a beam 2608 to a camera arm (not shown). Elongated pivot button 2602 can be pressed near the top, bottom, or in the middle and will provide the same releasing action as illustrated in the following figures.

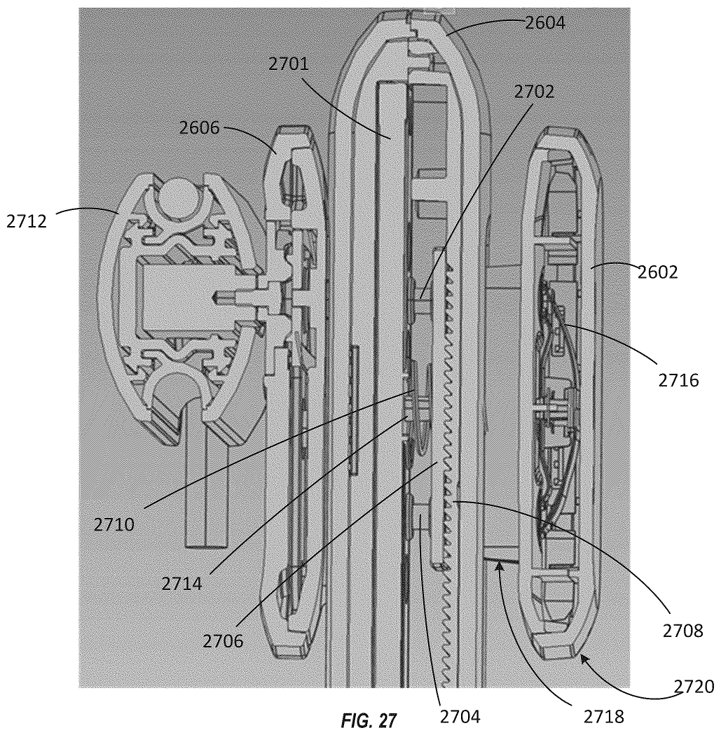

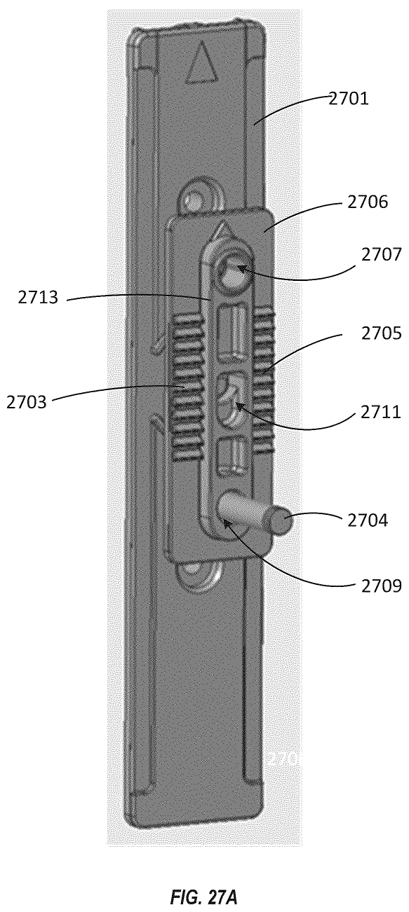

FIG. 27 is a cut-away view of the position adjustment button of FIG. 26, according to certain embodiments. Button 2602 is mounted on two pins 2702 and 2704 that connect button 2602, through openings in pole 2604, to an internal slider 2701 that is connected to a horizontal arm and has an internal rack gear 2706 mounted on slider 2701. Internal rack gear 2706 is spring-biased against an elongated gear 2708 on the interior of pole 2604 to hold internal rack gear 2706 in place at a desired vertical position. Pole 2604 includes two mating metal parts that are screwed together to create a frame for the internal parts. One of the internal metal parts has elongated gear 2708 on it. Slider 2701 and internal rack gear 2706 are connected to backside member 2606, which is attached to arm 2712, thus maintaining arm 2712 at the desired vertical position along pole 2604. A spring 2710 pushes against slider 2701 to bias internal rack gear 2706 against elongated gear 2708 to maintain their engagement. Spring 2710 is wound around a post 2714. Pins 2702 and 2704 on slider 2701 retain internal rack gear 2706. Backside member 2606 is screwed into a clutch plate assembly that is screwed into the horizontal slider with wheels trapped in 2712, as described in earlier embodiments. Backside member 2606 maintains a gap with arm 2712 and holds arm 2712 in place relative to pole 2604, but allows that position to be overcome in response to user movement of the camera which moves the arm, as described in earlier embodiments above.

FIG. 27A is a diagram of internal rack gear 2706, according to certain embodiments. As can be seen, there are actually two sets of rack gear teeth in parallel, rack gear teeth 2703 and rack gear teeth 2705. In between is an element 2713 where the button pushes against element 2713 to disengage the rack gear teeth from the elongated gear 2708 in the vertical pole 2604. Holes 2707 and 2709 provide for passage of pins 2702 and 2704. A central hole 2711 is where post 2714 extends through, with spring 2710 wrapped around it.

When button 2602 is pressed, an internal portion 2718 of button 2602 pushes against element 2713 between rack gears 2705 and 2706 against the force of spring 2710 to disengage internal rack gear 2706 from elongated gear 2708, thus allowing button 2602, backside member 2606 and arm 2712 to slide vertically along pole 2604. Depending on where the user pushes the button 2602, it will pivot around either pin 2702 or pin 2704 when pushed at the bottom or top, as illustrated in the following figures. An internal spring 2716 maintains the button in a vertical alignment (not pivoted) when it is not being pressed. Button 2602 contains an outer user pressable portion 2720 and an inner, shorter portion 2718 that extends through an opening in the pole 2604 to engage rack gear 2706. Inner portion 2718 of button 2602 has a convex surface that provides a pivoting action, as described below.

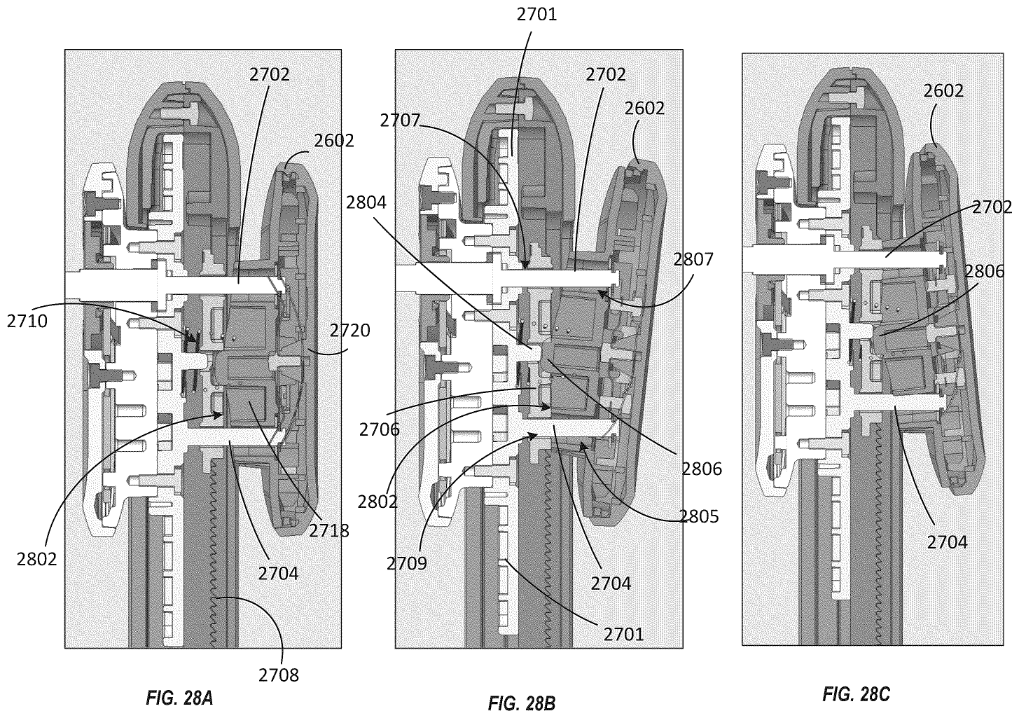

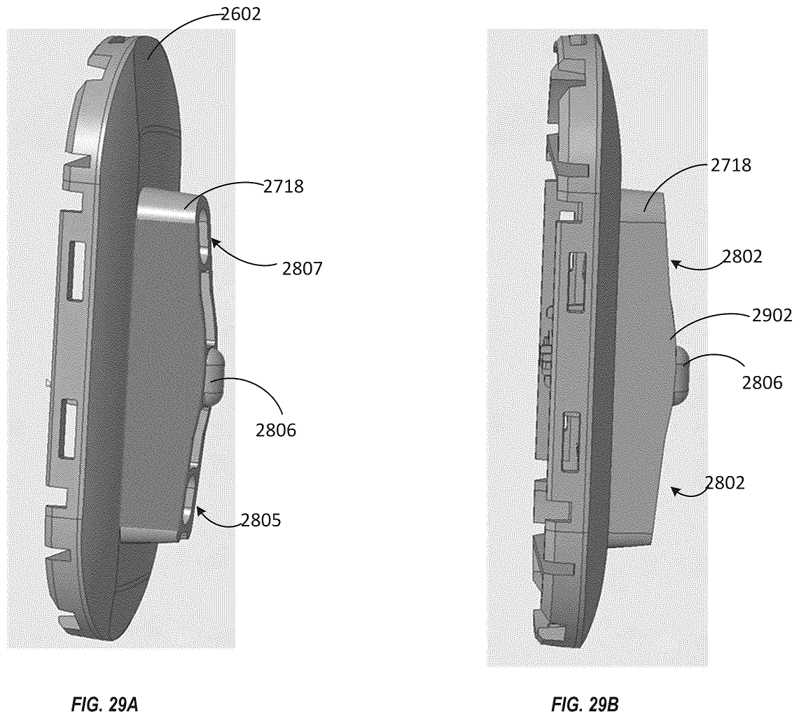

FIGS. 28A-C are cut-away views illustrating the pivoting of button 2602 when pressed from above or below, according to certain embodiments. FIG. 28A illustrates a neutral position of button 2602, with the spring 2710 uncompressed. An interior edge 2802 of inner portion 2718 of button 2602 is curved or angled, providing a pivot motion when pressed from above or below as illustrated in FIGS. 28 B-C. In embodiments, interior edge 2802 is curved or angled by 6-9 degrees. Alternately, it could be angled between 3-12 degrees. In embodiments, the angle is 9 degrees +/−3 degrees when the button is pressed at the top, and 6+/−3 degrees when the button is pressed at the bottom.

FIG. 28B shows button 2602 being pressed from the bottom. As can be seen, the middle and bottom of button 2602 pivots against pin 2702. The bottom portion pushes inward, causing the curved surface 2802 of inner portion 2718 of button 2602 to press the element 2713 between rack gears 2705 and 2706 inward, disengaging from elongated gear 2708. During the pivoting motion, a central plunger 2806 pushes against a spring 2710, closing the gap to post 2714. The curved surface 2802 of inner portion 2718 of button 2602 slides against member 2703, with the button pivoting around the end of pin 2702. Pins 2702 and 2704 extend through slots 2807 and 2805, respectively. Slots 2807 and 2805 are wide enough to allow such pivoting, as can be seen in FIG. 28B. In one embodiment, the slots 2807 and 2805 are 50-100 percent wider than the pins, allowing pivoting of the elongated pressable button around the pins. In contrast, holes 2707 and 2709 in rack gear 2706 are narrow, to maintain rack gear 2706 vertical as it is pushed in, avoiding binding of the gears. In addition, there is headroom beyond the ends of pins 2702 and 2704 so that the button can rotate without binding on the pins. As can be seen, there is a gap beyond the end of pin 2702 in FIG. 28B, while the pressing of the button at the bottom, and rotation inward, has used the headroom gap beyond pin 2704. Spring 2716 (see FIG. 27) between the ends of pins 2702 and 2704 maintains them in vertical alignment when the button is not pressed, since the large amount of play of slots 2807 and 2805 would otherwise allow the button to tilt.

FIG. 28C shows button 2602 being pressed from the top. This time, the button pivots around pin 2704, with the upper and middle portions of surface 2802 of inner portion 2718 of button 2602 pushing against and disengaging the internal rack gear 2706. Thus, button 2602 is easily pressed either in the middle, near the top, or near the bottom, with the same effect. This allows the user to access the button from in front, behind, or at another angle.

FIGS. 29A-B are views illustrating button 2602 and its inner portion 2718 in more detail, according to certain embodiments. The portion of the button that a user will press is removed and not shown, and would be on the left in the figures. Slots 2805 and 2807 for the pins are shown, along with plunger 2806. FIG. 29A is a perspective view, while FIG. 29B is a side view illustrating the angled inner surface 2802 of inner portion 2718. As can be seen, surface 2802 has an angle of between 5-10 degrees toward the top and bottom. A portion 2902 immediately adjacent to the plunger 2806 has a slightly steeper angle.

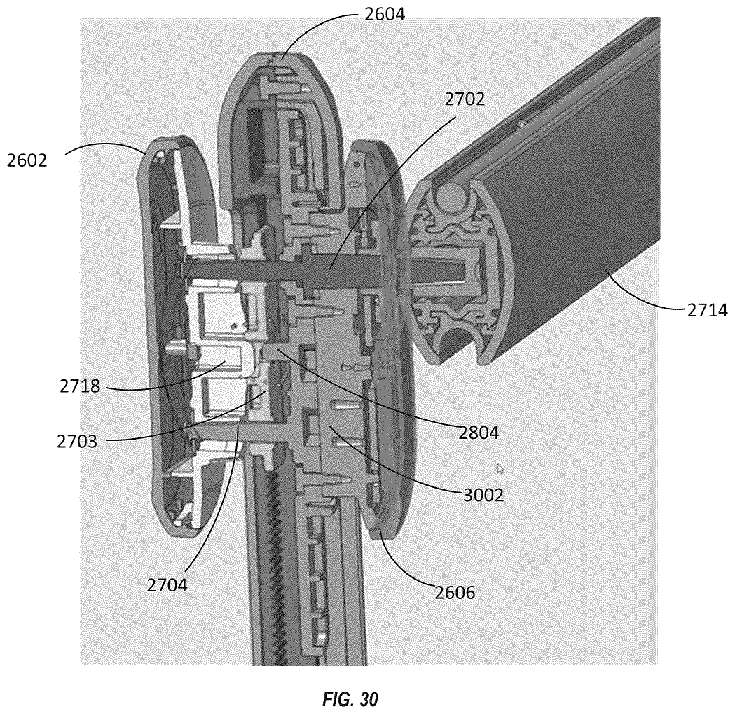

FIG. 30 is a cutaway view illustrating button 2602 and its connection to arm 2714, according to certain embodiments. Pin 2702 extends all the way from button 2602 into arm 2714. Pin 2704 just extends to slider 2701, which is slightly inward of part 3002, which is part of the clutch plate connected to backside member 2606, which is complementary in shape and size to button 2602. Also visible is interior portion 2718 of button 2602 and interior pin 2804. As can be seen, backside member 2606 extends slightly above arm 2714, and considerably below arm 2714. A person can press button 2602 at multiple positions directly, or could squeeze it with another finger or thumb on the back of arm 2714 or below arm 2714 directly on backside member 2606. The lower portion makes it easier for someone with smaller hands to grasp both sides, without also having to encompass arm 2714.

In alternate embodiments, the button can be on a horizontal arm, to move a pole left and right. Alternatively, instead of a pole, the button could be connected directly to a camera or other computer peripheral or other device, and directly move the device left and right along an arm.

In the embodiments shown, the teeth of elongated gear 2708 are angled upward. This provides a natural stop to keep the button and arm from sliding downward. At the same time, they allow the arm to be pushed upward with little or no pressure on button 2602, by overcoming the spring resistance.

Although button 2602 is shown for adjusting the vertical height along a pole of an arm, it could also be used to adjust the horizontal position of an arm with respect to a pole. A gear with teeth is shown in the described embodiments. For a horizontally moving button, square teeth could be used. However, the rack gear and elongated gear could be any complementary structures that engage with each other, such as pegs and holes.

### Host Computer System

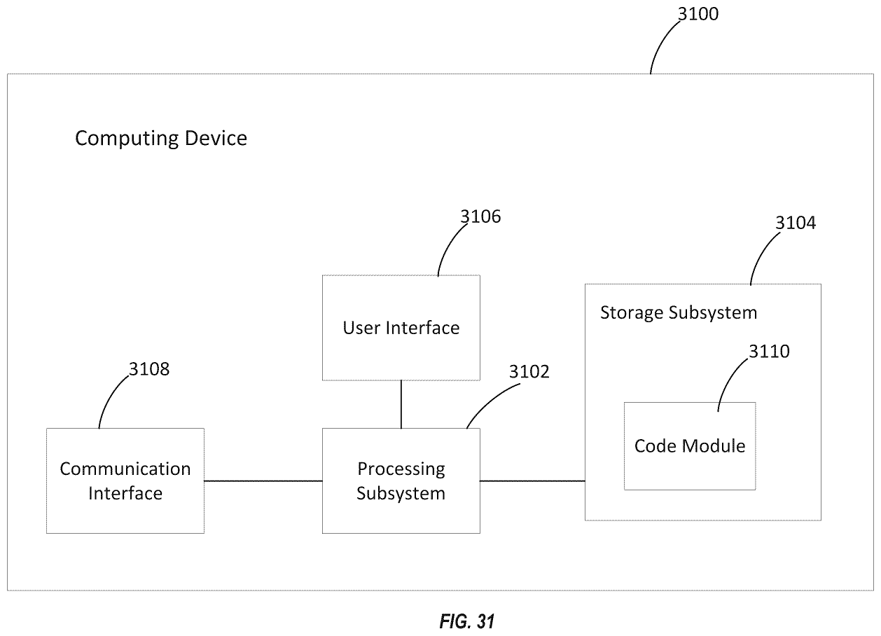

FIG. 31 is a simplified block diagram of a computing device 3100, according to certain embodiments. Computing device 3100 can implement some or all functions, behaviors, and/or capabilities described above that would use electronic storage or processing, as well as other functions, behaviors, or capabilities not expressly described. Computing device 3100 includes a processing subsystem 3102, a storage subsystem 3104, a user interface 3106, and/or a communication interface 3108. Computing device 3100 can also include other components (not explicitly shown) such as a battery, power controllers, and other components operable to provide various enhanced capabilities. In various embodiments, computing device 3100 can be implemented in a desktop or laptop computer, mobile device (e.g., tablet computer, smart phone, mobile phone), wearable device, media device, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electronic units designed to perform a function or combination of functions described above.

Storage subsystem 3104 can be implemented using a local storage and/or removable storage medium, e.g., using disk, flash memory (e.g., secure digital card, universal serial bus flash drive), or any other non-transitory storage medium, or a combination of media, and can include volatile and/or non-volatile storage media. Local storage can include random access memory (RAM), including dynamic RAM (DRAM), static RAM (SRAM), or battery backed up RAM. In some embodiments, storage subsystem 3104 can store one or more applications and/or operating system programs to be executed by processing subsystem 3102, including programs to implement some or all operations described above that would be performed using a computer. For example, storage subsystem 3104 can store one or more code modules 3110 for implementing one or more method steps described above.

A firmware and/or software implementation may be implemented with modules (e.g., procedures, functions, and so on). A machine-readable medium tangibly embodying instructions may be used in implementing methodologies described herein. Code modules 3110 (e.g., instructions stored in memory) may be implemented within a processor or external to the processor. As used herein, the term “memory” refers to a type of long term, short term, volatile, nonvolatile, or other storage medium and is not to be limited to any particular type of memory or number of memories or type of media upon which memory is stored.

Moreover, the term “storage medium” or “storage device” may represent one or more memories for storing data, including read only memory (ROM), RAM, magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing instruction(s) and/or data.

Furthermore, embodiments may be implemented by hardware, software, scripting languages, firmware, middleware, microcode, hardware description languages, and/or any combination thereof. When implemented in software, firmware, middleware, scripting language, and/or microcode, program code or code segments to perform tasks may be stored in a machine readable medium such as a storage medium. A code segment (e.g., code module 3110) or machine-executable instruction may represent a procedure, a function, a subprogram, a program, a routine, a subroutine, a module, a software package, a script, a class, or a combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted by suitable means including memory sharing, message passing, token passing, network transmission, etc.

Implementation of the techniques, blocks, steps and means described above may be done in various ways. For example, these techniques, blocks, steps and means may be implemented in hardware, software, or a combination thereof. For a hardware implementation, the processing units may be implemented within one or more ASICs, DSPs, DSPDs, PLDs, FPGAs, processors, controllers, micro-controllers, microprocessors, other electronic units designed to perform the functions described above, and/or a combination thereof.

Each code module 3110 may comprise sets of instructions (codes) embodied on a computer-readable medium that directs a processor of a computing device 3100 to perform corresponding actions. The instructions may be configured to run in sequential order, in parallel (such as under different processing threads), or in a combination thereof. After loading a code module 3110 on a general purpose computer system, the general purpose computer is transformed into a special purpose computer system.

Computer programs incorporating various features described herein (e.g., in one or more code modules 3110) may be encoded and stored on various computer readable storage media. Computer readable media encoded with the program code may be packaged with a compatible electronic device, or the program code may be provided separately from electronic devices (e.g., via Internet download or as a separately packaged computer readable storage medium). Storage subsystem 3104 can also store information useful for establishing network connections using the communication interface 3108.

User interface 3106 can include input devices (e.g., touch pad, touch screen, scroll wheel, click wheel, dial, button, switch, keypad, microphone, etc.), as well as output devices (e.g., video screen, indicator lights, speakers, headphone jacks, virtual- or augmented-reality display, etc.), together with supporting electronics (e.g., digital to analog or analog to digital converters, signal processors, etc.). A user can operate input devices of user interface 3106 to invoke the functionality of computing device 3100 and can view and/or hear output from computing device 3100 via output devices of user interface 3106. For some embodiments, the user interface 3106 might not be present (e.g., for a process using an ASIC).

Processing subsystem 3102 can be implemented as one or more processors (e.g., integrated circuits, one or more single core or multi core microprocessors, microcontrollers, central processing unit, graphics processing unit, etc.). In operation, processing subsystem 3102 can control the operation of computing device 3100. In some embodiments, processing subsystem 3102 can execute a variety of programs in response to program code and can maintain multiple concurrently executing programs or processes. At a given time, some or all of a program code to be executed can reside in processing subsystem 3102 and/or in storage media, such as storage subsystem 3104. Through programming, processing subsystem 3102 can provide various functionality for computing device 3100. Processing subsystem 3102 can also execute other programs to control other functions of computing device 3100, including programs that may be stored in storage subsystem 3104.

Communication interface 3108 can provide voice and/or data communication capability for computing device 3100. In some embodiments, communication interface 3108 can include radio frequency (RF) transceiver components for accessing wireless data networks (e.g., Wi-Fi network; 3G, 4G/LTE; etc.), mobile communication technologies, components for short range wireless communication (e.g., using Bluetooth communication standards, NFC, etc.), other components, or combinations of technologies. In some embodiments, communication interface 3108 can provide wired connectivity (e.g., universal serial bus, Ethernet, universal asynchronous receiver/transmitter, etc.) in addition to, or in lieu of, a wireless interface. Communication interface 3108 can be implemented using a combination of hardware (e.g., driver circuits, antennas, modulators/demodulators, encoders/decoders, and other analog and/or digital signal processing circuits) and software components. In some embodiments, communication interface 3108 can support multiple communication channels concurrently. In some embodiments the communication interface 3108 is not used.

It will be appreciated that computing device 3100 is illustrative and that variations and modifications are possible. A computing device can have various functionality not specifically described (e.g., voice communication via cellular telephone networks) and can include components appropriate to such functionality.

Further, while the computing device 3100 is described with reference to particular blocks, it is to be understood that these blocks are defined for convenience of description and are not intended to imply a particular physical arrangement of component parts. For example, the processing subsystem 3102, the storage subsystem, the user interface 3106, and/or the communication interface 3108 can be in one device or distributed among multiple devices.

Further, the blocks need not correspond to physically distinct components. Blocks can be configured to perform various operations, e.g., by programming a processor or providing appropriate control circuitry, and various blocks might or might not be reconfigurable depending on how an initial configuration is obtained. Embodiments of the present invention can be realized in a variety of apparatus including electronic devices implemented using a combination of circuitry and software. Electronic devices described herein can be implemented using computing device 3100.

### Method of Operating an Elongated Button

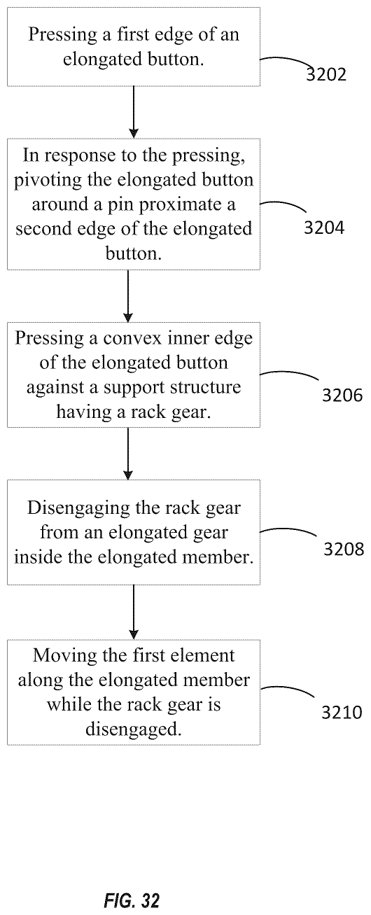

FIG. 32 is a flowchart of a method for operating an elongated button, according to certain embodiments. Step 3202 is pressing a first edge of an elongated button. Step 3204 is in response to the pressing, pivoting the elongated button around a pin proximate a second edge of the elongated button. Step 3206 is pressing a convex inner edge of the elongated button against a support structure having a rack gear. Step 3208 is disengaging the rack gear from an elongated gear inside the elongated member. Step 3210 is moving the first element along the elongated member while the rack gear is disengaged.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

What is claimed is:

1. An adjustable camera stand, comprising:
a base:
a pole extending from the base and being rotatable with respect to the base;
an arm extending horizontally from the pole;
a camera attached to the arm;
a camera attachment mechanism connecting the camera to the arm, including a user-graspable portion that rotates the camera with respect to the arm to hold the camera in a fixed orientation as a user movement of the camera causes the arm to extend and retract and causes the pole to rotate, thereby maintaining an image orientation of an image captured by the camera;
a height adjustment mechanism for adjusting a height of the arm on the pole; and
an extension mechanism in the arm that has enough friction to hold the arm in place but allows the arm to be extendable and retractable with respect to the pole in response to a user pulling or pushing the camera and causing the pole to rotate in response to force applied to the arm from the camera by the user.

2. The adjustable camera stand of claim 1 wherein the graspable portion is attached to the camera attachment mechanism with a slip ring.

3. The adjustable camera stand of claim 1 wherein the extension mechanism has sufficient friction to prevent movement of the arm in the absence of the application of force by a user.

4. The adjustable camera stand of claim 1 wherein the user-graspable portion is cylindrical and further comprising a hood attached to the user-graspable portion with a rectangular opening that visually aids the user with alignment of the camera image.

5. The adjustable camera stand of claim 4 further comprising a ball joint connecting the camera attachment mechanism to the arm.

6. The adjustable stand of claim 1 further comprising:
machine-readable non-transitory storage medium that includes instructions configured to cause one or more processors to perform operations including:
maintain an alignment of an image as the camera is moved.

7. The adjustable stand of claim 6 wherein the machine-readable non-transitory storage medium further includes instructions configured to cause one or more processors to maintain an alignment of an image of the camera in response to an alignment activation signal.

8. The adjustable stand of claim 1 wherein the alignment activation signal comprises one of:
a touch detection signal;
a signal in response to a detected gesture in a field of view of the camera;
a button activation;
a movement detection signal.

9. The adjustable stand of claim 1, further comprising:
an array of microphones mounted in the camera attachment mechanism.

10. The adjustable stand of claim 9 further comprising:
machine-readable non-transitory storage medium that includes instructions configured to cause one or more processors to perform operations including:
activating selected ones of the microphones in the array in response to a detected origin of sound.

11. An adjustable camera stand, comprising:
a base:
a pole extending from the base and being rotatable with respect to the base;
an arm extending horizontally from the pole;
a camera attached to the arm;
a camera attachment mechanism connecting the camera to the arm, including a user-graspable portion that rotates the camera with respect to the arm to hold the camera in a fixed orientation as a user movement of the camera causes the arm to extend and retract and causes the pole to rotate, thereby maintaining an image orientation of an image captured by the camera;
a ball joint connecting the camera attachment mechanism to the arm;
wherein the user-graspable portion is attached to the camera attachment mechanism with a slip ring;
wherein the user-graspable portion is cylindrical and further comprising a hood attached to the user-graspable portion with a rectangular opening that visually aids the user with alignment of the camera image;
a height adjustment mechanism for adjusting a height of the arm on the pole; and
an extension mechanism in the arm that has enough friction to hold the arm in place but allows the arm to be extendable and retractable with respect to the pole in response to a user pulling or pushing the camera and causing the pole to rotate in response to force applied to the arm from the camera by the user, wherein the extension mechanism has sufficient friction to prevent movement of the arm in the absence of the application of force by a user.

12. The adjustable stand of claim 11 further comprising:
machine-readable non-transitory storage medium that includes instructions configured to cause one or more processors to perform operations including:
maintain an alignment of an image as the camera is moved.

13. The adjustable stand of claim 12 wherein the machine-readable non-transitory storage medium further includes instructions configured to cause one or more processors to maintain an alignment of an image of the camera in response to an alignment activation signal.

14. The adjustable stand of claim 11 wherein the alignment activation signal comprises one of:
a touch detection signal;
a signal in response to a detected gesture in a field of view of the camera;
a button activation;
a movement detection signal.

15. The adjustable stand of claim 11, further comprising:
an array of microphones mounted in the camera attachment mechanism.

16. The adjustable stand of claim 15 further comprising:
machine-readable non-transitory storage medium that includes instructions configured to cause one or more processors to perform operations including:
activating selected ones of the microphones in the array in response to a detected origin of sound.

17. A method for adjusting a field of view of a camera attached to an adjustable stand, comprising:
grasping, by a user, a user-graspable portion of a camera attachment mechanism connecting the camera to a horizontal arm that is connected to a vertical pole connected to a base:
in response to user movement of the camera via the user-graspable portion, causing the horizontal arm to extend and retract with respect to the pole;
in response to user movement of the camera via the user-graspable portion, causing the pole to rotate with respect to the base in response to a twisting force applied to the pole through the arm;
holding the camera in a fixed orientation as a user movement of the camera causes the arm to extend and retract and causes the pole to rotate, thereby maintaining an image orientation of an image captured by the camera;
adjusting a height of the arm on the pole in response to operation of a height adjustment mechanism; and
applying sufficient friction to an extension mechanism in the arm to hold the arm in place but allow the arm to be extendable and retractable with respect to the pole in response to the user pulling or pushing the camera and causing the pole to rotate in response to force applied to the arm from the camera by the user.

18. The method of claim 17 wherein the user-graspable portion rotates in a first direction as it is moved by a user while maintaining the orientation of the camera, while the arm rotates in an opposite direction with respect to the base.

19. The method of claim 17 further comprising moving the camera and arm up and down with respect to the pole to provide a mechanical zoom.

20. The method of claim 17 further comprising rotating the camera 360 degrees with respect to the arm.
